(19) United States
(12) Patent Application Publication
(10) Pub. No.: US 2026/0139768 A1
(43) Pub. Date: May 21, 2026

(54) STAINLESS-STEEL CORRUGATED PIPE ASSEMBLY

(71) Applicant: TAIZHOU KLOE DAFENG PLUMBING CO., LTD., Taizhou City (CN)

(72) Inventors: Youchun Huang, Taizhou City (CN); Weijie Huang, Taizhou City (CN)

(21) Appl. No.: 19/005,291

(22) Filed: Dec. 30, 2024

(30) Foreign Application Priority Data
Nov. 21, 2024 (CN) 202411676110.X

(51) Int. Cl. F16L 11/15; F16L 19/025

(52) U.S. Cl. CPC F16L 11/15; F16L 19/025

(57) ABSTRACT

A stainless-steel corrugated pipe assembly, including a stainless-steel corrugated pipe, a water inlet connector connected to an end of the stainless-steel corrugated pipe, and a water outlet connector connected to another end of the stainless-steel corrugated pipe. A water inlet assembly is arranged in the water inlet connector, and a water outlet assembly is arranged in the water outlet connector; a transfer pipe is connected between the water inlet assembly and the water outlet assembly, and the transfer pipe is arranged in the stainless-steel corrugated pipe. In condition of the water outlet connector being in a turned-on state, high-pressure water entering the water inlet assembly opens the water outlet assembly through the transfer pipe; while the water inlet assembly and the water outlet assembly are connected to water, part of the stainless-steel corrugated pipe in the water inlet connector and the water outlet connector is further sealed.

### CROSS REFERENCE TO RELATED APPLICATIONS

The present application claims the priority of Chinese patent application No. 202411676110.X, filed on Nov. 21, 2024, and the entire contents of which are hereby incorporated by reference in its entirety.

### TECHNICAL FIELD

The present disclosure relates to the technical field of corrugated pipes, and specifically to a stainless-steel corrugated pipe assembly.

### BACKGROUND

A stainless-steel corrugated pipe is a complete component including a stainless-steel corrugated pipe and related parts to achieve a specific function in a specific application. Generally speaking, a stainless-steel corrugated pipe assembly consists of three main parts: a stainless-steel corrugated pipe, a sealing member, and a connector. The stainless-steel corrugated pipe, as the core component, has a regular corrugated shape. The corrugations are formed by alternating raised sections (crests) and sunken sections (troughs). The stainless-steel corrugated pipe itself has many characteristics, such as flexibility, corrosion resistance, and high-pressure resistance. The sealing member plays a role in preventing water leakage, and the connector plays a role in connection. The stainless-steel corrugated pipe assembly is widely applied in the connection of water and sewage.

The stainless-steel corrugated pipe is often applied in high-pressure environments. The long-term high-pressure environments may cause the connection between the connector and the stainless-steel corrugated pipe to crack and leak. When replacing and mounting a conventional stainless-steel corrugated pipe, since the connector is often fixed by welding or knocked with a hammer and then fixed with a nut, the replacement process is thus complicated and requires many auxiliary tools. In addition, the end of the stainless-steel corrugated pipe may not be flat after being knocked with the hammer, such that water leakage due to poor sealing often occurs during high-pressure use.

For this reason, the present disclosure is aimed to mitigate the problem of the conventional stainless-steel corrugated pipe being difficult to replace and mount and the connection between the connector and the stainless-steel corrugated pipe being prone to leak when used under high pressure, by providing a stainless-steel corrugated pipe assembly, thereby avoiding the risk of water leakage from the stainless-steel corrugated pipe.

### SUMMARY OF THE DISCLOSURE

The purpose of the present disclosure is to provide a stainless-steel corrugated pipe assembly, to solve the technical problems raised in the above background art.

In view of this, the present disclosure provides a stainless-steel corrugated pipe assembly, including: a stainless-steel corrugated pipe, a water inlet connector connected to an end of the stainless-steel corrugated pipe, and a water outlet connector connected to another end of the stainless-steel corrugated pipe; wherein a water inlet assembly is arranged in the water inlet connector, and a water outlet assembly is arranged in the water outlet connector; a transfer pipe is connected between the water inlet assembly and the water outlet assembly, and the transfer pipe is arranged in the stainless-steel corrugated pipe; in condition of the water outlet connector being in a turned-on state, high-pressure water entering the water inlet assembly opens the water outlet assembly through the transfer pipe; while the water inlet assembly and the water outlet assembly are connected to water, part of the stainless-steel corrugated pipe in the water inlet connector and the water outlet connector is further sealed.

In some embodiments, the water inlet assembly includes a first stopper, and a first piston is connected to an end of the first stopper towards inside the stainless-steel corrugated pipe; the first piston is sealed and slidably connected within a first gas cylinder.

In some embodiments, the water outlet assembly includes a second stopper, and a second piston is connected to an end of the second stopper towards outside the stainless-steel corrugated pipe; the second piston is sealed and slidably connected within a second gas cylinder.

In some embodiments, a first limiting ring body is arranged in the water inlet connector, and a plurality of first fixing members are arranged in the first limiting ring body for fixing an end of the stainless-steel corrugated pipe near the water inlet connector; each first fixing member includes a first crest and a second crest adapted to troughs of the stainless-steel corrugated pipe.

In some embodiments, a second limiting ring body is arranged in the water outlet connector 300, and a plurality of second fixing members are arranged in the second limiting ring body for fixing an end of the stainless-steel corrugated pipe near the water outlet connector; each second fixing member includes a third crest and a fourth crest adapted to the troughs of the stainless-steel corrugated pipe.

In some embodiments, gas storage sections are arranged between the stainless-steel corrugated pipe and the transfer pipe.

In some embodiments, a first elastic member is arranged in the first gas cylinder; in condition of the first elastic member being in a relaxed state, the water inlet assembly is capable of blocking the transfer pipe at a water inlet end via the first stopper; in condition of the first elastic member being compressed to a set position, the water inlet assembly is capable of being in communication with the transfer pipe.

In some embodiments, a second elastic member is arranged in the second gas cylinder; in condition of the second elastic member being in a relaxed state, the water outlet component is capable of blocking the transfer pipe at a water outlet end via the second stopper; in condition of the second elastic member being compressed to another set position, the water outlet component is capable of being in communication with the transfer pipe.

In some embodiments, the water inlet assembly includes a first inflation ring defining an air vent, and the first gas cylinder defines an air outlet hole; in condition of the first elastic member in the first gas cylinder being in a compressed state, compressed gas in the first gas cylinder enters the first inflation ring through the air outlet hole and a pipe and inflates at least one of the gas storage sections close to the water inlet connector.

In some embodiments, the water outlet assembly includes a second inflation ring defining another air vent, and the second gas cylinder defines another air outlet hole; in condition of the second elastic member in the second gas cylinder being in another compressed state, compressed gas in the second gas cylinder enters the second inflation ring through the air outlet hole on the second inflation ring and another pipe and inflates at least one of the gas storage sections close to the water outlet connector.

The beneficial effects of the present disclosure are:
1. When connecting the stainless-steel corrugated pipe and the water inlet connector, the first fixing members that are snapped onto the outer wall and end surface of the stainless-steel corrugated pipe are simultaneously limited by the first limiting ring body, thereby achieving a quick connection between the stainless-steel corrugated pipe and the water inlet connector. Furthermore, a gasket is arranged on a connection end of the angle valve or valve to continuously squeeze the multiple first fixing members, such that the multiple first fixing members limit the end surface of the stainless-steel corrugated pipe as the water inlet connector rotates further, thereby further preventing the stainless-steel corrugated pipe from becoming detached from the water inlet connector and leaking under water pressure.
2. When water is connected, high-pressure water makes the first stopper sliding in the water inlet assembly. The movement of the first stopper causes the first piston to move within the first gas cylinder. The movement of the first piston within the first gas cylinder continuously presses against the first elastic member. The first piston compresses the first elastic member and the gas in the first gas cylinder, causing the gas storage section at the second crest expands and squeezes the inner wall of the stainless-steel corrugated pipe and the transfer pipe and the water inlet assembly, causing the water inlet connector and the end of the stainless-steel corrugated pipe to fit more closely, so as to improve the sealing effect.
3. When the water pressure is further increased, the compressed gas in the first gas cylinder can be further compressed, and the further compressed gas enters the gas storage sections between the first crest and the second crest through the second crest, which can further squeeze the transfer pipe, the water inlet assembly, and the stainless-steel corrugated pipe, thereby enhancing the sealing effect of the connection between the water inlet/outlet connector and the stainless-steel corrugated pipe under the environment of high water-pressure, and thus prevent the connection from loosening, falling off, or rupturing and leaking, which may affect normal use.

### BRIEF DESCRIPTION OF THE DRAWINGS

FIG. 1 is a schematic view of an overall structure according to some embodiments of the present disclosure.

FIG. 2 is a full sectional view of an overall structure according to some embodiments of the present disclosure.

FIG. 3 is a schematic view of a water inlet connector according to some embodiments of the present disclosure.

FIG. 4 is a structural schematic view of a water inlet assembly according to some embodiments of the present disclosure.

FIG. 5 is a cross-sectional schematic view of a first gas cylinder according to some embodiments of the present disclosure.

FIG. 6 is a cross-sectional schematic view of a water inlet connector according to some embodiments of the present disclosure.

FIG. 7 is a partial enlarged view of area A circumscribed in FIG. 6.

FIG. 8 is an exploded view of a first fixing member according to some embodiments of the present disclosure.

FIG. 9 is a schematic view of a water outlet connector according to some embodiments of the present disclosure.

FIG. 10 is a cross-sectional view of a second inflation ring according to some embodiments of the present disclosure.

FIG. 11 is a cross-sectional view of a second gas cylinder according to some embodiments of the present disclosure.

FIG. 12 is a cross-sectional view of a water outlet connector according to some embodiments of the present disclosure.

FIG. 13 is a partial enlarged view of area B circumscribed in FIG. 12.

FIG. 14 is an exploded view of a second fixing member according to some embodiments of the present disclosure.

FIG. 15 is a schematic view of a water outlet connector, according to some embodiments of the present disclosure, in a water-passing state.

FIG. 16 is a schematic view of a water inlet connector, according to some embodiments of the present disclosure, in a water-passing state.

Reference numerals:
100, stainless-steel corrugated pipe;
200, water inlet connector;
210, water inlet assembly; 211, first stopper; 212, first piston; 213, first gas cylinder; 214, first elastic member; 215, first inflation ring;
220, first limiting ring body; 221, first fixing member; 2210, first crest; 2211, second crest;
300, water outlet connector;
310, water outlet assembly; 311, second stopper; 312, second piston; 313, second gas cylinder; 314, second elastic element; 315, second inflation ring;
320, second limiting ring body; 321, second fixing member; 3210, third crest; 3211, fourth crest;
400, transfer pipe;
500, gas storage section.

### DETAILED DESCRIPTION

The following will provide a clear and complete description of the technical solutions in the embodiments of the present disclosure in conjunction with the accompanying drawings. Obviously, the described embodiments are only some embodiments of the present disclosure, not all of the embodiments. Based on the embodiments of the present disclosure, all other embodiments obtained by those skilled in the art without creative effort fall within the scope of the present disclosure.

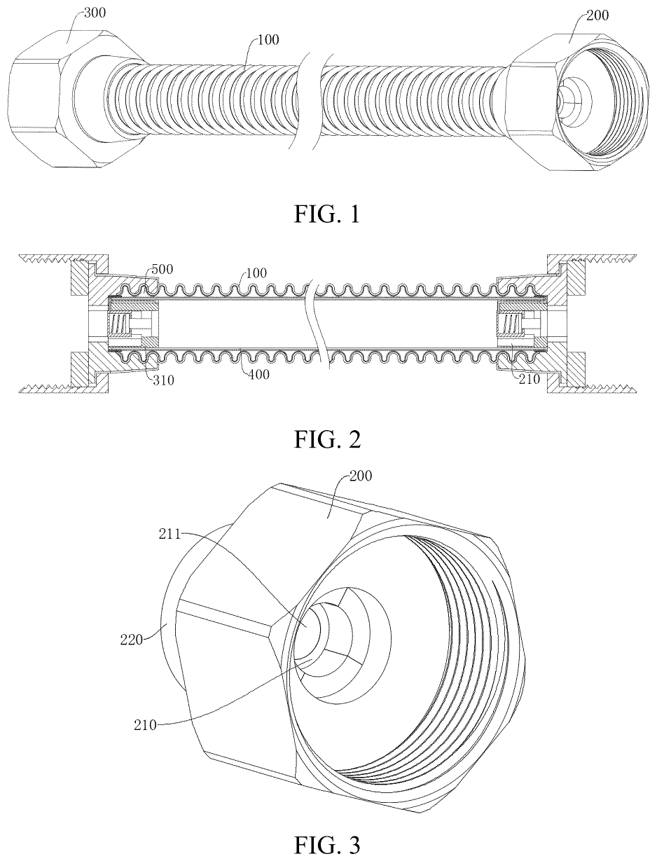

Referring to FIG. 1, embodiments of the present disclosure provide a stainless-steel corrugated pipe assembly including a stainless-steel corrugated pipe 100, a water inlet connector 200 connected to an end of the stainless-steel corrugated pipe 100, and a water outlet connector 300 connected to another end of the stainless-steel corrugated pipe 100, where the water inlet connector 200 is connected to a water inlet pipe, and the water outlet connector 300 is connected to a faucet or a valve. The stainless-steel corrugated pipe 100, the water inlet connector 200, and the water outlet connector 300 are all made of stainless steel instead of a traditional brass material, which is more resistant to acids and bases and is not easily corroded or scaled.

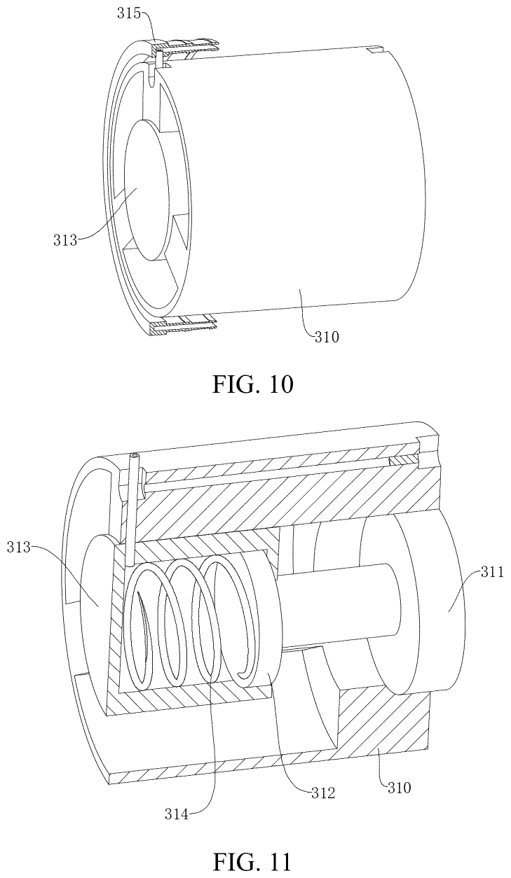

Referring to FIGS. 2 and 3, a water inlet assembly 210 is arranged in the water inlet connector 200, and in combination with FIG. 9, a water outlet assembly 310 is arranged in the water outlet connector 300, and a transfer pipe 400 is connected between the water inlet assembly 210 and the water outlet assembly 310. The transfer pipe 400 is arranged in the stainless-steel corrugated pipe 100.

Since the water outlet connector 300 is connected to a faucet or valve, when the faucet or valve is turned on and the water outlet connector 300 is in a turned-on state, high-pressure water entering the water inlet assembly 210 opens the water outlet assembly 310 through the transfer pipe 400, and the water source can enter the faucet or valve through the water outlet connector 300 and flow out through the faucet or valve. While the water inlet assembly 210 and the water outlet assembly 310 are connected to water, part of the stainless-steel corrugated pipe 100 in the water inlet connector 200 and the water outlet connector 300 is further sealed.

For a more detailed implementation of the above scheme, specifically, referring to FIGS. 3, 4, and 5, the water inlet assembly 210 includes a first stopper 211, and a first piston 212 is connected to an end of the first stopper 211 towards inside the stainless-steel corrugated pipe 100, where the first piston 212 is sealed and slidably connected within a first gas cylinder 213.

Referring to FIGS. 10 and 11, the water outlet assembly 310 includes a second stopper 311, and a second piston 312 is connected to an end of the second stopper 311 towards outside the stainless-steel corrugated pipe 100. The second piston 312 is sealed and slidably connected within a second gas cylinder 313.

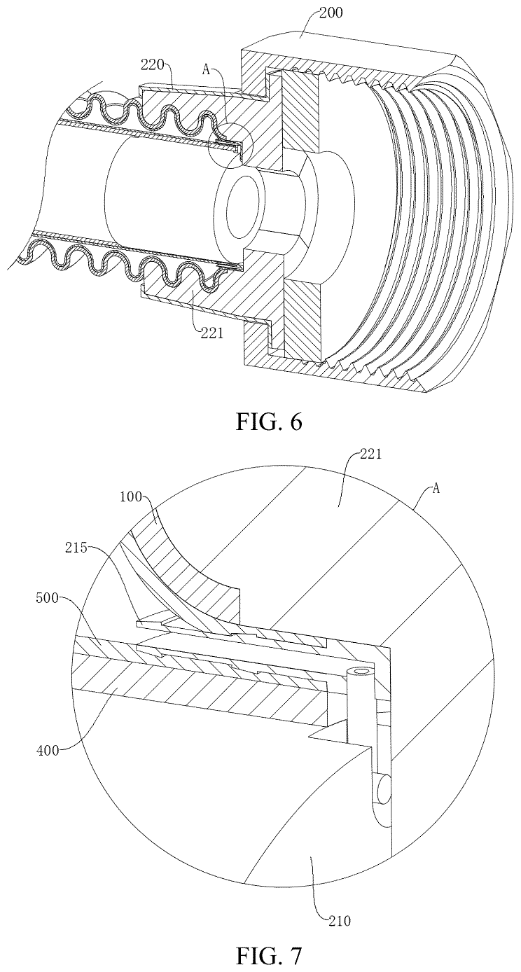

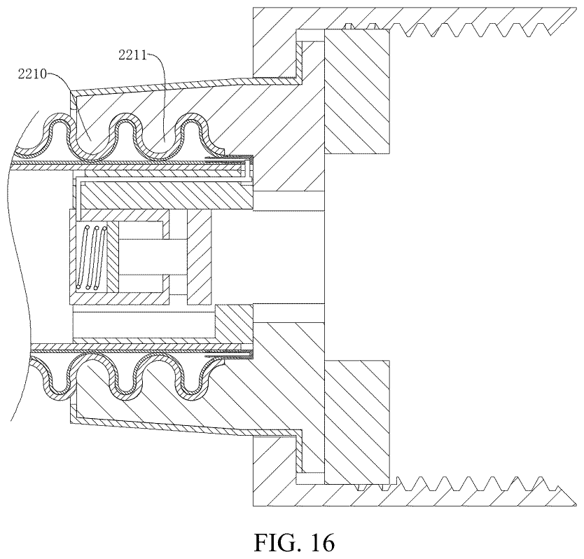

Referring to FIGS. 6, 8, and 16, a first limiting ring body 220 is arranged in the water inlet connector 200, and multiple first fixing members 221 are arranged in the first limiting ring body 220 for fixing an end of the stainless-steel corrugated pipe 100 near the water inlet connector 200. Each first fixing member 221 is made of a material with an elastic sealing function, and the first fixing member 221 includes a first crest 2210 and a second crest 2211 adapted to troughs of the stainless-steel corrugated pipe 100. It should be noted that the height of the first crest 2210 is greater than the height of the second crest 2211. The purpose of this arrangement is that when the first limiting ring body 220 limits the first fixing members 221, the stainless-steel corrugated pipe 100 is initially compressed and limited by the first crest 2210.

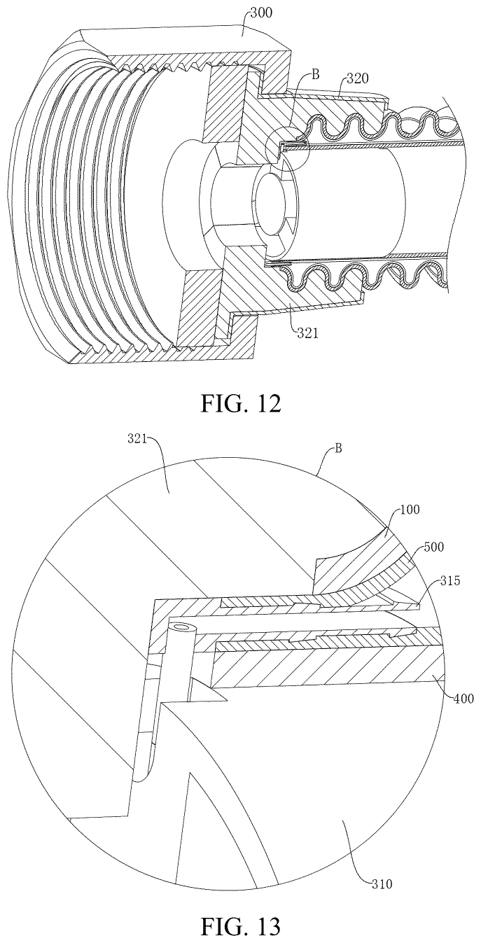

Referring to FIGS. 9, 12, and 14, a second limiting ring body 320 is arranged in the water outlet connector 300, and multiple second fixing members 321 are arranged in the second limiting ring body 320 for fixing an end of the stainless-steel corrugated pipe 100 near the water outlet connector 300. Each second fixing member 321 has the same characteristics as the first fixing member 221. Referring to FIG. 15, the second fixing member 321 includes a third crest 3210 and a fourth crest 3211 adapted to the troughs of the stainless-steel corrugated pipe 100. It should be noted that the height of the third crest 3210 is greater than the height of the fourth crest 3211. The purpose of this arrangement is that when the second limiting ring body 320 limits the second fixing members 321, the stainless-steel corrugated pipe 100 is initially compressed and limited by the third crest 3210.

Regarding the arrangement proposed in the present embodiments, the conventional stainless-steel corrugated pipe is integrated with the first fixing members and cannot be replaced individually by the first fixing members. On the contrary, the conventional stainless-steel corrugated pipe and the first fixing members are required to be replaced as a whole. In the embodiments of the present disclosure, by arranging the multiple first fixing members 221, the stainless-steel corrugated pipe 100 can be replaced individually while ensuring a strong tightness and connection reliability. During replacement, the water inlet connector 200 is sleeved on the stainless-steel corrugated pipe 100; four the first fixing members 221 are evenly snapped on the outer surface and end surface of the stainless-steel corrugated pipe 100, and the first fixing members 221 that are snapped onto the outer wall and end surface of the stainless-steel corrugated pipe are simultaneously limited by the first limiting ring body 220, thereby achieving a quick connection between the stainless-steel corrugated pipe 100 and the water inlet connector 200. In addition, the first limiting ring body 220 extrudes and limits the first fixing members 221, causing the first fixing members 221 to be pressed against each other within the first limiting ring body 220, so as to interact with each other and form an integral whole to limit and seal the stainless-steel corrugated pipe 100. Moreover, when it is necessary to replace the corrugated pipe 100, the positional limitation on the multiple first fixing members is released through the first limiting ring body 220, such that the multiple first fixing members 221 become independent and versatile individuals.

When the stainless-steel corrugated pipe 100 is connected to the angle valve or valve via the water inlet connector 200, as the water inlet connector 200 rotates, the water inlet connector 200 is engaged with the external thread of the angle valve or valve via the internal thread, and at the same time, the first limiting ring body 220 can be made to continuously move closer to the angle valve or valve with the water inlet connector 200. The first limiting ring body 220 continuously squeezes the first fixing members 221 when moving, causing the first crest 2210 of the first fixing member 221 to first fit against a corresponding trough of the stainless-steel corrugated pipe 100, such that the first crest 2210 of the first fixing member 221 squeezes the trough of the stainless-steel corrugated pipe 100 under the action of friction. Similarly, as the water inlet connector 200 further rotates, the water inlet the water inlet connector 200 rotates, driving the first limiting ring body 220 to continue to squeeze the first fixing member 221, such that in addition to the first crest 2210 squeezing the corresponding trough of the stainless-steel corrugated pipe 100, the second crest 2211 further squeezes a corresponding trough of the stainless-steel corrugated pipe 100, thereby ensuring the firmness and tightness of the connection between the stainless-steel corrugated pipe 100 and the water inlet connector 200. Furthermore, a gasket is arranged on a connection end of the angle valve or valve to continuously squeeze the multiple first fixing members 221, such that the multiple first fixing members 221 limit the end surface of the stainless-steel corrugated pipe 100 as the water inlet connector 200 rotates further, thereby further preventing the stainless-steel corrugated pipe 100 from becoming detached from the water inlet connector 200 and leaking under water pressure.

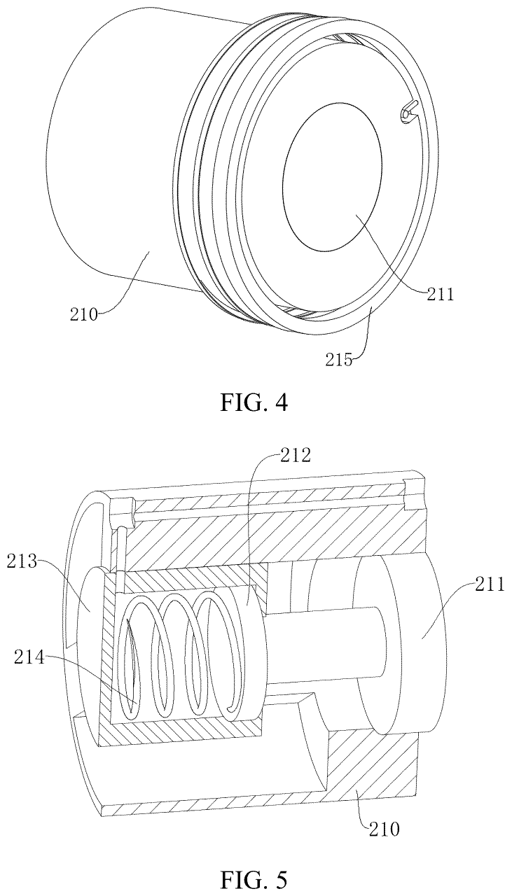

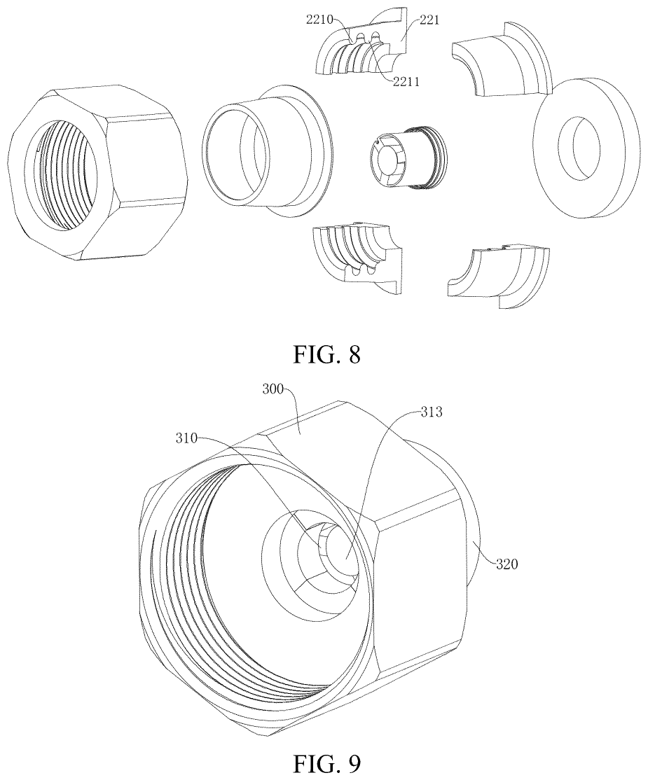

Referring to FIG. 2, gas storage sections 500 are arranged between the stainless-steel corrugated pipe 100 and the transfer pipe 400. Combining FIGS. 5, 6, and 7, a first elastic member 214 is arranged in the first gas cylinder 213, where the first elastic member 214 is a spring. When the first elastic member 214 is in a relaxed state, the water inlet assembly 210 can block the transfer pipe 400 at a water inlet end via the first stopper 211. When the first elastic member 214 is compressed to a set position, the water inlet assembly 210 can be in communication with the transfer pipe 400. Combining FIGS. 4 and 5, the water inlet assembly 210 includes a first inflation ring 215 defining an air vent, and the first gas cylinder 213 defines an air outlet hole. When the first elastic member 214 in the first gas cylinder 213 is in a compressed state, the compressed gas in the first gas cylinder 213 enters the first inflation ring 215 through the air outlet hole and a pipe and inflates at least one of the gas storage sections 500 close to the water inlet connector 200.

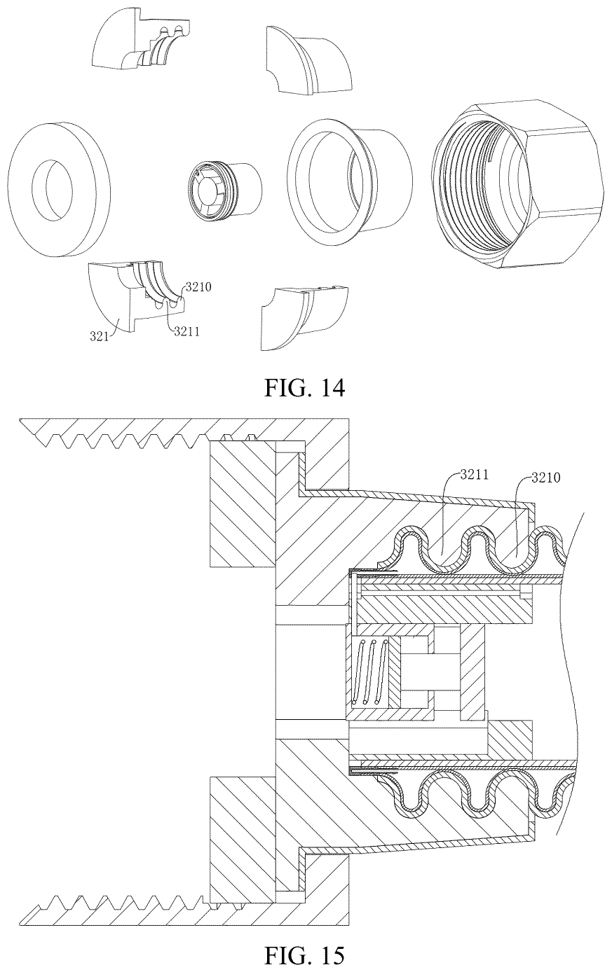

Referring to FIGS. 11, 12, and 13, a second elastic member 314 is arranged in the second gas cylinder 313, where the second elastic member 314 is a spring. When the second elastic member 314 is in a relaxed state, the water outlet component 310 can block the transfer pipe 400 at a water outlet end via the second stopper 311, and when the second elastic member 314 is compressed to a set position, the water outlet component 310 can be in communication with the transfer pipe 400.

Referring to FIGS. 10, 12, and 13, the water outlet assembly 310 includes a second inflation ring 315 defining an air vent, and the second gas cylinder 313 defines an air outlet hole. When the second elastic member 314 in the second gas cylinder 313 is in a compressed state, the compressed gas in the second gas cylinder 313 enters the second inflation ring 315 through the air outlet hole and a pipe and inflates at least one of the gas storage sections 500 close to the water outlet connector 300.

In the above embodiments, when the angle valve or valve is turned on, the high-pressure water in the faucet or valve presses against the first stopper 211, causing the first stopper 211 to slide within the water inlet assembly 210. The movement of the first stopper 211 causes the first piston 212 to move within the first gas cylinder 213. The movement of the first piston 212 within the first gas cylinder 213 continuously presses against the first elastic member 214. While the first piston 212 is squeezing the first elastic member 214, it is also squeezing the gas in the first gas cylinder 213. The compressed gas in the first gas cylinder 213 enters the first inflation ring 215 through the air outlet hole and the pipe. The compressed gas in the first inflation ring 215 inflates the gas storage section 500 at the second crest 2211. The gas storage section 500 expands and squeezes the inner wall of the stainless-steel corrugated pipe 100, causing the outer wall of the stainless-steel corrugated pipe 100 to fit more closely against the first fixing member 221. The first piston 212 compresses the first elastic member 214 and the gas in the first gas cylinder 213, causing the gas storage section 500 at the second crest 2211 expands and squeezes the inner wall of the stainless-steel corrugated pipe 100 and the transfer pipe 400 and the water inlet assembly 210, causing the water inlet connector 200 and the end of the stainless-steel corrugated pipe 100 to fit more closely and prevent loosening. In addition, as the water pressure continues to increase, the first stopper 211 moves further in the direction of the first gas cylinder 213 within the water inlet assembly 210. As the first stopper 211 moves, the first piston 212 continuously squeezes the first elastic member 214 in the first gas cylinder 213. The gas in the first gas cylinder 213 is further compressed by the first piston 212, and the pressure of the compressed gas in the gas storage section 500 at the second crest 2211 further increases. As the pressure continues to increase, the compressed gas passes through the second crest 2211 and enters the gas storage sections 500 between the first crest 2210 and the second crest 2211. With the first plug 211 being squeezed to move, the pressure of the compressed gas in the gas storage sections 500 between the first crest 2210 and the second crest 2211 gradually increases. In this way, during the usage of high-pressure water, the gas storage sections 500 between the first crest 2210 and the second crest 2211 are charged with pressurized gas, causing the gas storage sections 500 between the first crest 2210 and the second crest 2211 to expand further, thereby further squeezing the inner wall of the stainless-steel corrugated pipe 100. Further, the gas storage sections 500 at the first crest 2210 and the second crest 2211 are charged with pressurized gas during the usage of high-pressure water, causing the gas storage sections 500 at the first fixing members 221 to expand and compress the transfer pipe 400, the water inlet assembly 210, and the stainless-steel corrugated pipe 100.

As the pressure of the water used to impact the first stopper 211 gradually increases, the first stopper 211 moves further in the direction of the first gas cylinder 213 within the water inlet assembly 210. The movement of the first stopper 211 causes the first piston 212 to move synchronously within the first gas cylinder 213. The first piston 212 is synchronized to move with the first stopper 211 being pressed, causing the compressed gas in the first gas cylinder 213 to be compressed further. As the water pressure increases, the compressed gas enters the gas storage sections 500 between the first crest 2210 and the second crest 2211 through the second crest 2211, thereby making the greater the water pressure, the greater the gas pressure entering the gas storage sections 500 between the first crest 2210 and the second crest 2211. Further, the gas storage sections 500 at the first crest 2210 and the second crest 2211 are charged with pressurized gas during the usage of high-pressure water, causing the gas storage sections 500 at the first fixing members 221 to expand and compress the transfer pipe 400, the water inlet assembly 210, and the stainless-steel corrugated pipe 100, thereby preventing serious water damage and safety hazards caused by the connection between the water inlet connector 200 and the stainless-steel corrugated pipe 100 loosening, falling off, or rupturing and leaking when used under high pressure for a long time.

Based on the above embodiments, the same reasoning can be applied to the effect of the end of the stainless-steel corrugated pipe 100 with the water outlet connector 300.

The above is only some embodiments of the present disclosure, but the scope of the present disclosure is not limited thereto. Those skilled in the art can make equivalent substitutions or changes based on the technical solution and inventive concept of the present disclosure, which shall be covered by the scope of the present disclosure.

What is claimed is:

1. A stainless-steel corrugated pipe assembly, comprising: a stainless-steel corrugated pipe (100), a water inlet connector (200) connected to an end of the stainless-steel corrugated pipe (100), and a water outlet connector (300) connected to another end of the stainless-steel corrugated pipe (100); wherein a water inlet assembly (210) is arranged in the water inlet connector (200), and a water outlet assembly (310) is arranged in the water outlet connector (300); a transfer pipe (400) is connected between the water inlet assembly (210) and the water outlet assembly (310), and the transfer pipe (400) is arranged in the stainless-steel corrugated pipe (100); in condition of the water outlet connector (300) being in a turned-on state, high-pressure water entering the water inlet assembly (210) opens the water outlet assembly (310) through the transfer pipe (400); while the water inlet assembly (210) and the water outlet assembly (310) are connected to water, part of the stainless-steel corrugated pipe (100) in the water inlet connector (200) and the water outlet connector (300) is further sealed.

2. The stainless-steel corrugated pipe assembly according to claim 1, wherein the water inlet assembly (210) comprises a first stopper (211), and a first piston (212) is connected to an end of the first stopper (211) towards inside the stainless-steel corrugated pipe (100); the first piston (212) is sealed and slidably connected within a first gas cylinder (213).

3. The stainless-steel corrugated pipe assembly according to claim 2, wherein the water outlet assembly (310) comprises a second stopper (311), and a second piston (312) is connected to an end of the second stopper (311) towards outside the stainless-steel corrugated pipe (100); the second piston (312) is sealed and slidably connected within a second gas cylinder (313).

4. The stainless-steel corrugated pipe assembly according to claim 3, wherein a first limiting ring body (220) is arranged in the water inlet connector (200), and a plurality of first fixing members (221) are arranged in the first limiting ring body (220) for fixing an end of the stainless-steel corrugated pipe (100) near the water inlet connector (200); each first fixing member (221) comprises a first crest (2210) and a second crest (2211) adapted to troughs of the stainless-steel corrugated pipe (100).

5. The stainless-steel corrugated pipe assembly according to claim 4, wherein a second limiting ring body (320) is arranged in the water outlet connector (300), and a plurality of second fixing members (321) are arranged in the second limiting ring body (320) for fixing an end of the stainless-steel corrugated pipe (100) near the water outlet connector (300); each second fixing member (321) comprises a third crest (3210) and a fourth crest (3211) adapted to the troughs of the stainless-steel corrugated pipe (100).

6. The stainless-steel corrugated pipe assembly according to claim 5, wherein gas storage sections (500) are arranged between the stainless-steel corrugated pipe (100) and the transfer pipe (400).

7. The stainless-steel corrugated pipe assembly according to claim 6, wherein a first elastic member (214) is arranged in the first gas cylinder (213); in condition of the first elastic member (214) being in a relaxed state, the water inlet assembly (210) is capable of blocking the transfer pipe (400) at a water inlet end via the first stopper (211); in condition of the first elastic member (214) being compressed to a set position, the water inlet assembly (210) is capable of being in communication with the transfer pipe (400).

8. The stainless-steel corrugated pipe assembly according to claim 7, wherein a second elastic member (314) is arranged in the second gas cylinder (313); in condition of the second elastic member (314) being in a relaxed state, the water outlet component (310) is capable of blocking the transfer pipe (400) at a water outlet end via the second stopper (311); in condition of the second elastic member (314) being compressed to another set position, the water outlet component (310) is capable of being in communication with the transfer pipe (400).

9. The stainless-steel corrugated pipe assembly according to claim 8, wherein the water inlet assembly (210) comprises a first inflation ring (215) defining an air vent, and the first gas cylinder (213) defines an air outlet hole; in condition of the first elastic member (214) in the first gas cylinder (213) being in a compressed state, compressed gas in the first gas cylinder (213) enters the first inflation ring (215) through the air outlet hole and a pipe and inflates at least one of the gas storage sections (500) close to the water inlet connector (200).

10. The stainless-steel corrugated pipe assembly according to claim 9, wherein the water outlet assembly (310) comprises a second inflation ring (315) defining another air vent, and the second gas cylinder (313) defines another air outlet hole; in condition of the second elastic member (314) in the second gas cylinder (313) being in another compressed state, compressed gas in the second gas cylinder (313) enters the second inflation ring (315) through the air outlet hole on the second inflation ring (315) and another pipe and inflates at least one of the gas storage sections (500) close to the water outlet connector (300).
